(19) United States
(12) Patent Application Publication
(10) Pub. No.: US 2014/0108130 A1
(43) Pub. Date: Apr. 17, 2014

(54) CALCULATING AUDIENCE METRICS FOR ONLINE CAMPAIGNS

(71) Applicant: Google Inc., Mountain View, CA (US)

(72) Inventors: Wiesner J. Vos, Surbiton (GB); James R. Koehler, Boulder, CO (US); Evgeny Skvortsov, Kitchener (CA); Lukas Rutishauser, Kirkland, WA (US)

(21) Appl. No.: 13/672,780

(22) Filed: Nov. 9, 2012

Related U.S. Application Data
(60) Provisional application No. 61/713,073, filed on Oct. 12, 2012.

(51) Int. Cl. G06Q 30/02

(52) U.S. Cl. CPC G06Q 30/0246
USPC 705/14.45

(57) ABSTRACT

Methods, systems, and apparatus, including computer programs encoded on a computer-readable storage medium, for determining performance for a campaign. A method includes: identifying a campaign associated with the delivery of an electronic media item; identifying identifiers of devices that were served impressions of the electronic media item; determining a number of unique identifiers that received impressions and a number of views of the electronic media item per identifier; identifying a plurality of demographic categories; identifying labeled identifiers; determining a number of identifiers and views per demographic category for the campaign; accumulating un-labeled identifiers to produce a count of un-labeled identifiers and views; determining, for the labeled identifiers, a distribution across the plurality of demographic categories; adjusting for errors in the determined distribution; determining an overall distribution among the demographic categories for impressions; and applying the overall distribution to a total number of unique identifiers and views for the campaign.

### CROSS-REFERENCE TO RELATED APPLICATION

This application claims priority to U.S. Provisional Application No. 61/713,073, filed on Oct. 12, 2012. The disclosure of the prior application is considered part of and is incorporated by reference in the disclosure of this application.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for determining performance for a campaign. The method comprises: identifying a campaign associated with the delivery of an electronic media item over an online network; identifying data associated with impressions of electronic media items over the online network, each entry in the data including an identifier associated with a requesting device that was served a given impression; determining a number of unique identifiers that received impressions of the electronic media item and a number of views of the electronic media item per identifier; identifying a plurality of demographic categories; identifying, from the unique identifiers, labeled identifiers, wherein a labeled identifier is able to be resolved to a particular user that has known demographic characteristics; using the labeled identifiers, determining a number of identifiers and views per demographic category for the campaign; accumulating the un-labeled identifiers to produce a count of un-labeled identifiers and views; determining, for the labeled identifiers, a distribution across the plurality of demographic categories; adjusting for errors in the determined distribution including compensating for a first error factor associated with a known error bias in the number of labeled identifiers and a second error factor associated with an underrepresentation of any group in the demographic characteristics; determining an overall distribution among the demographic categories for impressions using the determined distribution and the first and second error factors; and applying the overall distribution to a total number of unique identifiers and views including applying the overall distribution to the un-labeled identifiers to determine the overall distribution of identifiers and views per demographic category for the campaign.

In general, another aspect of the subject matter described in this specification can be implemented in computer program products that include a computer program product tangibly embodied in a computer-readable storage device. The computer program product can include instructions that, when executed by a processor, cause the processor to: identify a campaign associated with the delivery of an electronic media item over an online network; identify data associated with impressions of electronic media items over the online network, each entry in the data including an identifier associated with a requesting device that was served a given impression; determine a number of unique identifiers that received impressions of the electronic media item and a number of views of the electronic media item per identifier; identify a plurality of demographic categories; identify, from the unique identifiers, labeled identifiers, wherein a labeled identifier is able to be resolved to a particular user that has known demographic characteristics; use the labeled identifiers to determine a number of identifiers and views per demographic category for the campaign; accumulate the un-labeled identifiers to produce a count of un-labeled identifiers and views; determine, for the labeled identifiers, a distribution across the plurality of demographic categories; adjust for errors in the determined distribution including compensating for a first error factor associated with a known error bias in the number of labeled identifiers and a second error factor associated with an underrepresentation of any group in the demographic characteristics; determine an overall distribution among the demographic categories for impressions using the determined distribution and the first and second error factors; and apply the overall distribution to a total number of unique identifiers and views including applying the overall distribution to the un-labeled identifiers to determine the overall distribution of identifiers and views per demographic category for the campaign.

In general, another aspect of the subject matter described in this specification can be implemented in systems. A system includes a content management system, log data, and panel data. The content management system is configured to: identify a campaign associated with the delivery of an electronic media item over an online network; identify, from the log data, data associated with impressions of electronic media items over the online network, each entry in the data including an identifier associated with a requesting device that was served a given impression; determine a number of unique identifiers that received impressions of the electronic media item and a number of views of the electronic media item per identifier; identify a plurality of demographic categories; identify, from the unique identifiers, labeled identifiers, wherein a labeled identifier is able to be resolved to a particular user that has known demographic characteristics; use the labeled identifiers to determine a number of identifiers and views per demographic category for the campaign; accumulate the un-labeled identifiers to produce a count of un-labeled identifiers and views; determine, for the labeled identifiers, a distribution across the plurality of demographic categories; using the panel data, adjust for errors in the determined distribution including compensating for a first error factor associated with a known error bias in the number of labeled identifiers and a second error factor associated with an underrepresentation of any group in the demographic characteristics; determine an overall distribution among the demographic categories for impressions using the determined distribution and the first and second error factors; and apply the overall distribution to a total number of unique identifiers and views including applying the overall distribution to the un-labeled identifiers to determine the overall distribution of identifiers and views per demographic category for the campaign.

These and other implementations can each optionally include one or more of the following features. The identifiers can be cookies. A number of people that viewed the electronic media item in a given demographic category can be determined based at least in part on the total number of unique identifiers. A GRP (Gross Rating Point) can be determined for the campaign for a demographic category as the number of people times the number of views in the demographic category divided by a total number of people available in the demographic category in a given region. The region can be a country. The electronic media item can be an advertisement. The distribution can be defined by a vector X, where the i-th component of X is the fraction of labeled identifiers in the i-th demographic category. An alpha-value can be determined for the campaign, where the alpha-value represents a fraction of labeled identifiers to unlabeled identifiers. The alpha-value can be used when adjusting for errors. Adjusting for errors can include determining a Y value, where Y=alpha-value*AX+(1−alpha-value)*BX/|BX| and where A and B are predetermined matrices. Determining an overall distribution among the demographic categories for impressions can include extrapolating a demographic identifier distribution to all identifiers including multiplying Y by the number of unique identifiers for the campaign. Adjusting for errors can include adjusting to compensate for errors in assigning users labels that are in the data. Adjusting for errors can include adjusting for bias in a labeling methodology used to label users. Adjusting for errors can include adjusting for underrepresentation of a demographic group in the demographic categories based at least in part on the labels. Determining the number of unique identifiers that received impressions of the electronic media item can be based at least in part on a calibration panel. The second error factor can compensate for demographic bias in the calibration panel. The data can be log data.

Particular implementations may realize none, one or more of the following advantages. A campaign sponsor can be provided a gross rating point measure of an online audience and can compare such a measure to similar measures that are available for other media sources such as print and television. A campaign sponsor can be provided an estimate of the number of unique people in an online audience. A campaign sponsor can be provided an estimate of a demographic distribution of an online audience.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 is a flowchart of an example process for determining performance for a campaign.

FIG. 3 is a block diagram of an example system for reporting performance for a campaign.

FIG. 4 illustrates an example performance report.

FIG. 5 is a block diagram of computing devices that may be used to implement the systems and methods described in this document, as either a client or as a server or plurality of servers.

Like reference numbers and designations in the various drawings indicate like elements.

### DETAILED DESCRIPTION

A campaign sponsor may desire to know performance of a content campaign. For example, the sponsor may desire to know how many people viewed a content item, how many times the content item was viewed, and which types of users viewed a given content item. A content management system can provide a report to a campaign sponsor which includes information such as reach, frequency, gross rating point (GRP), and/or a demographic distribution of a reached audience. Reach can be defined as the number of unique users exposed to a particular content item during a particular period of time. Frequency refers to the average number of times a unique user viewed a given content item over the time period. Gross rating point is a measure that can be calculated, such as normalized reach times frequency.

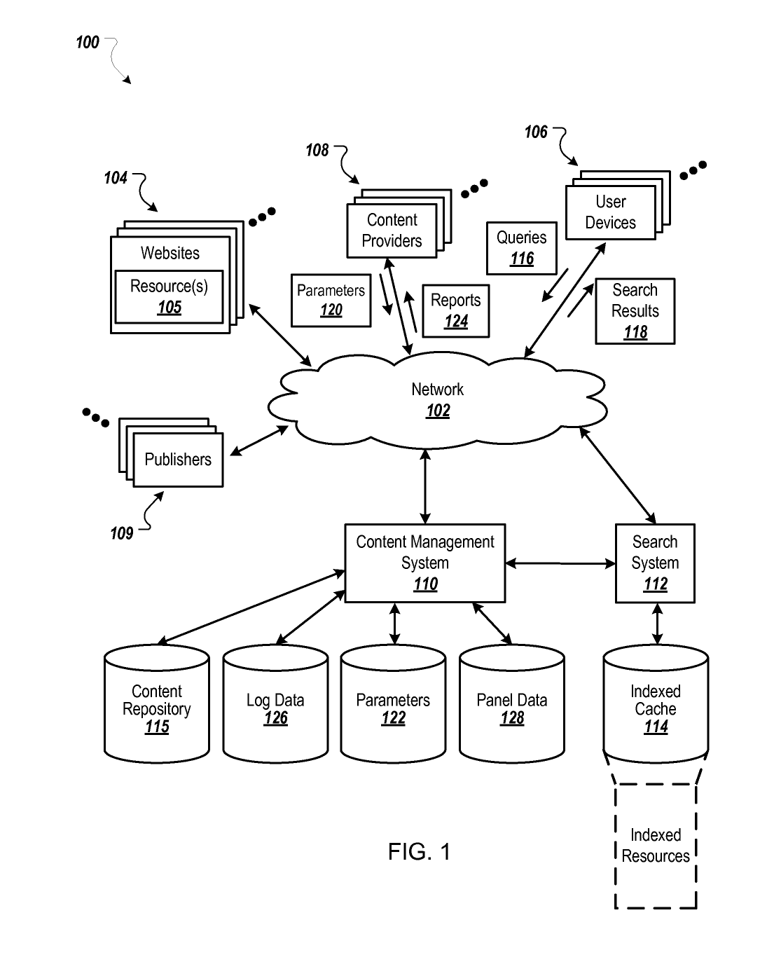

FIG. 1 is a block diagram of an example environment 100 for providing content to a user. The example environment 100 includes a network 102 such as a local area network (LAN), wide area network (WAN), the Internet, or a combination thereof. The network 102 connects websites 104, user devices 106, content providers 108, publishers 109, and a content management system 110. The example environment 100 may include many thousands of websites 104, user devices 106, content providers 108, and publishers 109.

A website 104 includes one or more resources 105 associated with a domain name and hosted by one or more servers. An example website 104 is a collection of webpages formatted in hypertext markup language (HTML) that can contain text, images, multimedia content, and programming elements, e.g., scripts. Each website 104 is maintained by, for example, a publisher 109, e.g., an entity that controls, manages and/or owns the website 104.

A resource 105 is any data that can be provided over the network 102. A resource 105 is identified by a resource address that is associated with the resource 105. Resources 105 include HTML pages, word processing documents, and portable document format (PDF) documents, images, video, and feed sources, to name only a few examples. The resources 105 can include content, e.g., words, phrases, images and sounds that may include embedded information (such as meta-information in hyperlinks) and/or embedded instructions (such as JavaScript scripts).

To facilitate searching of resources 105, the environment 100 can include a search system 112 that identifies the resources 105 by crawling and indexing the resources 105 provided by the publishers 109 on the websites 104. Data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices, tablet devices, and other devices that can send and receive data over the network 102. A user device 106 typically includes a user application, such as a web browser, to facilitate the sending and receiving of data over the network 102 and the presentation of content to a user.

A user device 106 can request resources 105 from a website 104. In turn, data representing the resource 105 can be provided to the user device 106 for presentation by the user device 106. User devices 106 can also submit search queries 116 to the search system 112 over the network 102. In response to a search query 116, the search system 112 can access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource (“resource keywords”) or a search query 116 for which search results 118 are requested can also be provided to the content management system 110 to facilitate identification of content that is relevant to the resource or search query 116. A request for a resource 105 or a search query 116 can also include an identifier, such as a cookie, identifying the requesting user device 106 (e.g., in instances in which the user consents in advance to the use of such an identifier).

Based, for example, on data included in the request for content, the content management system 110 can select content items that are eligible to be provided in response to the request, such as content items having characteristics matching the characteristics of a given slot. As another example, content items having selection keywords that match the resource keywords or the search query 116 may be selected as eligible content items by the content management system 110. Content items may be selected, for example from a content repository 115. One or more selected content items can be provided to the user device 106 in association with providing an associated resource 105 or search results 118. In some implementations, the content management system 110 can select content items based at least in part on results of an auction. For example, for the eligible content items, the content management system 110 can receive bids from content providers 108 and allocate the slots, based at least in part on the received bids (e.g., based on the highest bidders at the conclusion of the auction).

In some implementations, some content providers 108 prefer that the number of impressions allocated to their content and the price paid for the number of impressions be more predictable than the predictability provided by an auction. A content provider 108 can increase the likelihood that its content receives a desired or specified number of impressions, for example, by entering into an agreement with a publisher 109, where the agreement requires the publisher 109 to provide at least a threshold number of impressions (e.g., 1,000 impressions) for a particular content item provided by the content provider 108 over a specified period (e.g., one week). In turn, the content provider 108, publisher 109, or both parties can provide data to the content management system 110 that enables the content management system 110 to facilitate satisfaction of the agreement.

For example, the content provider 108 can upload a content item and authorize the content management system 110 to provide the content item in response to requests for content corresponding to the website 104 of the publisher 109. Similarly, the publisher 109 can provide the content management system 110 with data representing the specified time period as well as the threshold number of impressions that the publisher 109 has agreed to allocate to the content item over the specified time period. Over time, the content management system 110 can select content items based at least in part on a goal of allocating at least a minimum number of impressions to a content item in order to satisfy a delivery goal for the content item during a specified period of time.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define the content campaign. The campaign parameters 120 can be stored in a parameters data store 122. Campaign parameters 120 can include, for example, a campaign name, a preferred content network for placing content, a budget for the campaign, start and end dates for the campaign, a schedule for content placements, content (e.g., a creatives), and selection criteria. Selection criteria can include, for example, a language, one or more geographical locations or websites, and one or more selection terms. The content campaign can be created and activated for the content provider 108 according to the parameters 120 specified by the content provider 108.

A content provider 108 may desire to know performance of a content campaign. For example, the content provider 108 may desire to know reach, frequency, gross rating point, and/or a demographic distribution for the content campaign. The content management system 110 can determine such information and can provide one or more reports 124 to the content provider 108. As described in more detail below, in some implementations, to determine performance information, the content management system 110 can determine a number of unique identifiers (e.g., cookies) associated with the campaign, determine which and how many identifiers are associated with labels, determine a distribution across the plurality of demographic categories for the labeled identifiers, adjust for errors in the determined distribution, extrapolate to determine an overall distribution for all identifiers for the campaign, and determine user counts based on the overall distribution.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from a content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

The content management system 110 can, for example, determine identifiers and labels from log data 126. In some implementations, the content management system 110 can use one or more models (e.g., cookie to user models) to infer the number of users associated with a particular identifier. In some implementations, the content management system 110 uses one or more models derived from online calibration panel data 128 for error correction as is described in further detail below.

The content provider 108 can use the reports 124 to understand the performance of content campaigns. Including gross rating point information in the reports 124 allows the content provider 108 to easily compare the performance of the content campaign against other campaigns used in other media, such as print and television, since gross rating point is a measurement that is commonly available for campaigns using such other types of media.

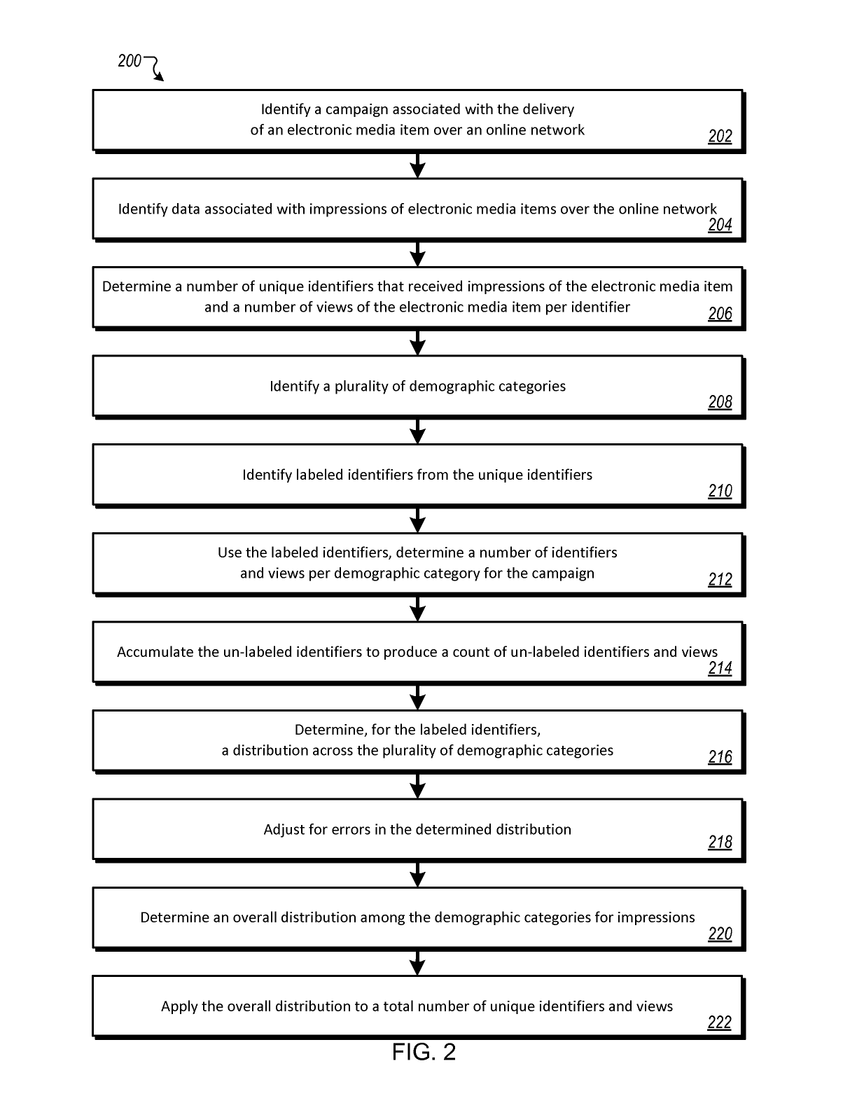

FIG. 2 is a flowchart of an example process 200 for determining performance for a campaign. The process 200 can be performed, for example, by the content management system 110 described above with respect to FIG. 1.

A campaign associated with the delivery of an electronic media item over an online network is identified (202). For example, the electronic media item can be an advertisement or some other type of content item. The campaign can be a content campaign that is sponsored, for example, by a campaign sponsor or a content provider (e.g., an advertiser).

Data associated with impressions of electronic media items over the online network is identified (204). For example, the content management system 110 can identify the log data 126. Each entry in the log data can include an identifier associated with a requesting device that was served a given impression. The identifiers can be, for example, cookies, or some other type of identifier. The log data can include information for users who have previously consented to collection of such information.

A number of unique identifiers that received impressions of the electronic media item and a number of views of the electronic media item per identifier are determined (206). For example, the content management system 110 can identify log data 126 that is associated with the identified campaign, and can determine the number of unique identifiers in the identified log data 126. The content management system 110 can determine the number of views for an identifier as the number of occurrences of the identifier in the identified log data 126.

A plurality of demographic categories is identified (208). For example, a set of predefined demographic categories can be identified. The predefined set of identified demographic categories can be different in different implementations. In some implementations, the predefined set of demographic categories includes gender and a set of age categories. The age categories can include, for example, ages seventeen and under, eighteen to twenty four, twenty five to thirty four, thirty five to forty four, forty five to fifty four, fifty five to sixty four, and sixty five and above.

Labeled identifiers are identified from the unique identifiers (210). A labeled identifier can be resolved, for example, to a particular type of user that has known demographic characteristics. In some implementations, labels can be determined based on data associated with a particular publisher property (e.g., a label-providing publisher). For example, a user can register with a label-providing publisher, such as a video sharing service, and can consent to providing certain demographic information, such as gender and/or age, and can consent to such information being associated with a labeled identifier which can be an identifier of a user device associated with the user. In some implementations, the content management system 110 can receive such a labeled identifier in association with a request for content to be presented on the label-providing publisher site and can store such a labeled identifier in the log data 126. Labels associated with the labeled identifier can be referred to as publisher-provided labels.

The content management system 110 can subsequently identify entries in the log data 126 that include or are associated with publisher-provided labels. The content management system 110 can identify other entries in the log data 126 that include or are otherwise associated with an identified labeled identifier, such as requests for content for presentation on other publisher properties that include a labeled identifier previously included in a request for content for presentation on a label-providing publisher.

In some implementations, when the content management system 110 identifies more than one set of publisher-provided labels associated with an identifier (e.g., if a user device was used to register at multiple label-providing publishers), the content management system 110 can combine the multiple sets of publisher-provided labels or can select one set of the multiple sets of publisher-provided labels. For example, the content management system 110 can select a set of publisher-provided labels that is associated with a publisher that is deemed to be more reliable than another publisher.

The labeled identifiers are used to determine a number of identifiers and views per demographic category for the campaign (212). For example, if the demographic categories include gender and age categories, the content management system 110 can determine which and how many labeled identifiers are associated with each gender and age category, can determine how many views are associated with each determined labeled identifier, and can sum, for each category, the views associated with the respective category.

The un-labeled identifiers are accumulated to produce a count of un-labeled identifiers and views (214). For example, the content management system 110 can determine which and how many identifiers are not labeled identifiers and are not associated with a labeled identifier. The content management system can determine the number of un-labeled views, for example, by determining how many entries in the log data 126 that are associated with the campaign are associated with an un-labeled identifier.

A distribution for the labeled identifiers is determined across the plurality of demographic categories (216). For example, in some implementations, the distribution is defined by a vector X, where X=aDa+bDb+ . . . +zDz, where a+b+ . . . +z=1, based on counts of labeled identifiers in a respective demographic group D. In other words, in the vector X, the i^{th} component is equal to the fraction of the number of labeled identifiers in an i^{th} demographic bucket to the total number of labeled identifiers. In a simple example, suppose that there are two labels, male and female, and that out of thirty labeled identifiers, ten are male and twenty are female. A vector X for this example can be X=(0.33, 0.67).

An adjustment for errors is made in the determined distribution (218), including compensating for a first error factor associated with a known error bias in the number and/or assignment of labeled identifiers and a second error factor associated with, for example, an underrepresentation of any group in the demographic characteristics. For example, the content management system 110 can use the first error factor to compensate for errors in assigning user labels that are in the data (e.g., log data 122). For example, an estimated adjustment can be determined to account for users lying about or misrepresenting their age. As another example, the content management system 110 can adjust for bias in a labeling methodology used to label users. For example, the first error factor can correspond to situations where one user uses a computing device that uses an identifier of a previously logged in user.

Another example of adjustments include adjusting for under-representation of a demographic group in the demographic categories based at least in part on the labels. For example, a prior determination may have been made (or it may be known) that the distribution for a given property (or set of properties) for the labeled identifiers is not representative of the general population. For example, a determination may be made that more males than females visit a given publisher site that is the source of the label information, so identifying a male label in the data may be more likely than identifying a female label. To account for such a difference in likelihood, the second error factor can be used, which, in this example, can provide a higher weight to an identified female label and a lower weight to an identified male label.

The likelihood of identifying a particular label (e.g., male, female, or another label, such as a particular age range) can be determined based on a calibration panel. The calibration panel can be, for example, a probability-recruited online panel that is aligned, for example, to the overall online population of a particular country (e.g., the United States) using data from an official population survey (e.g., the United States Current Population Survey (CPS)) on a set of key demographic variables using demographic weights. The panel can be calibrated to the population data, for example, using a calibration method such as generalized regression estimators (GREG), Random Iterative Method (RIM)-weighting, or post-stratification. Using a combination of the label-based estimation and the panel can enable use of a panel of a smaller size than if the panel was used for estimation without the label-based estimation.

An overall distribution is determined among the demographic categories for impressions using the determined distribution and the first and second error factors (220). In some implementations, an alpha-value is determined for the campaign, where the alpha-value represents a fraction of labeled identifiers to unlabeled identifiers. The alpha-value can be used in determining the overall distribution. For example, a Y distribution can be determined, where Y=alpha-value*AX+(1−alpha-value)*BX/|BX|, where A and B are predetermined matrices. For example, A can be a stochastic correction matrix and B can be a positive redistribution matrix. In some implementations, the matrices A and B can be determined by machine learning (e.g., linear regression), including training based on historical campaigns and on the calibration panel.

The above formula for Y assumes one source for label information. If multiple sources for label information are used, the formula can be adjusted, such as to include multiple alpha values. For example, suppose that there are P sets of labeled identifiers, and included in the P sets are, for example, among other sets, a first set that has labels from a first publisher, a second set that has labels from a second publisher, and a third set that has labels for both the first and second publisher. In this example, the alpha-value can be decomposed such that alpha-value=sum{p=1, . . . , P} (alpha_p-value), where an alpha_p-value represents a fraction of identifiers that have labels from a subset “p”. P sets of a vector X and a correction matrix A can be identified, for example (X_p, A_p) for each subset p. In this example, the above equation for Y can be modified to Y=sum{p=1, . . . , P} alpha_p-value*A_pX_p+(1−alpha-value)*BX/|BX|, where X=(x_{—}1′, x_{—}2′, . . . , x_P′)′ which is a concatenation of all of the subset distributions.

In some implementations, multiple subsets of unlabeled identifiers can exist. For example, a first subset of unlabeled desktop identifiers and a second subset of unlabeled mobile device identifiers can be identified. In such an example, for the equation for Y, the expression (1−alpha-value) can be decomposed into proportions for the unlabeled identifiers with a unique “B” matrix for each proportion. For example, “Q” subsets of the unlabeled identifiers with proportion gamma_q for a q^{th} subset can be identified. The expression (1−alpha-value) can be determined to be (1−alpha-value)=sum{q=1, . . . , Q} (gamma_q). In this example, the formula for Y becomes Y=sum{p=1, . . . , P} alpha_p-value*A_pX_p+sum{q=1, . . . , Q} gamma_q*B_qX/|B_qX|, where X=(x_{—}1′, x_{—}2′, . . . , x_P′)′, which is the concatenation of all of the subset distributions.

The overall distribution is applied to a total number of unique identifiers and views (222), including applying the overall distribution to the un-labeled identifiers to determine the overall distribution of identifiers and views per demographic category for the campaign. For example, the content management system 110 can extrapolate the demographic identifier distribution to all identifiers by multiplying Y by the number of unique identifiers for the campaign.

In some implementations, the content management system 110 determines a number of people that viewed the electronic media item in a given demographic category based at least in part on the total number of unique identifiers. For example, the number of people for a demographic category can be derived from the total number of unique identifiers using an identifier to people model. For example, the identifier to people model can account for the fact that a user may be associated with more than one cookie (e.g., if a user uses more than one device or browser) and that a cookie can be associated with more than one user (e.g., if multiple users share a device). In some implementations, a GRP can be determined for the campaign for each demographic category as the number of people times the number of views in the demographic category divided by a total number of people available in the demographic category in a given region (e.g., where the region may be a country or some other region).

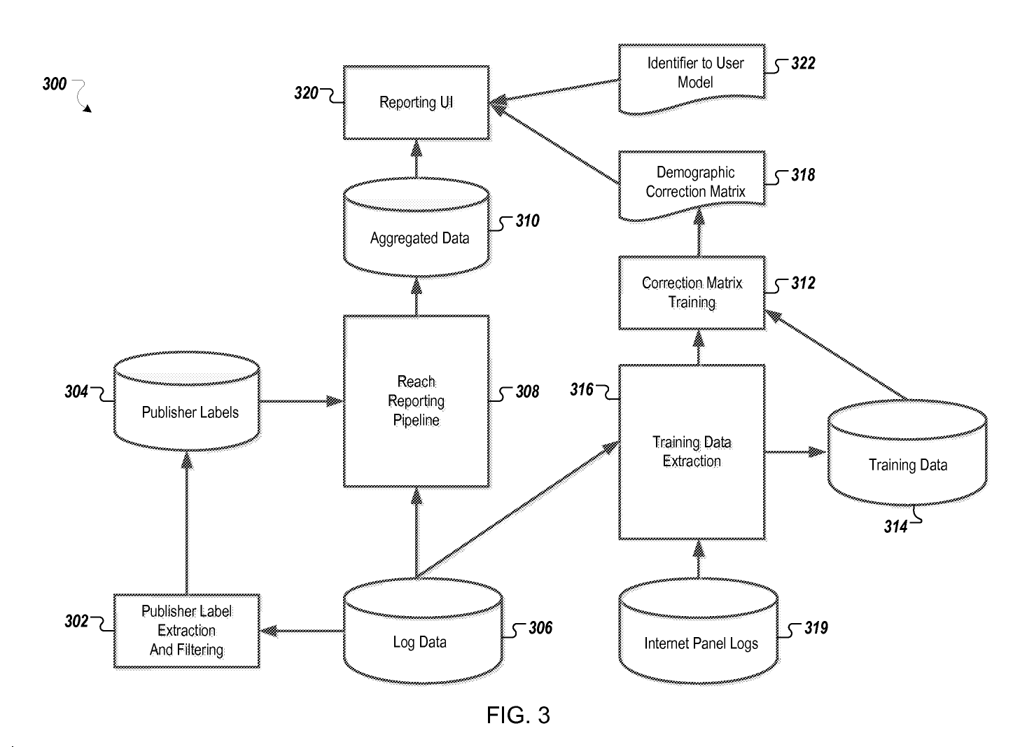

FIG. 3 is a block diagram of an example system 300 for reporting performance for a campaign. A publisher label extraction and filtering component 302 can determine and store publisher label data 304 based on log data 306. The log data 306 includes information associated with impressions of electronic media items over an online network, where each entry includes an identifier associated with a requesting device that was served a given impression. Some of the entries in the log data 306 include label information and some entries do not include label information.

The publisher label data 304 can include information that maps identifiers to demographic labels. In some implementations, the publisher label extraction and filtering component 302 can filter out (e.g., not use) log data 306 that is older than a certain number of days (e.g., thirty days). The publisher label extraction and filtering component 302 can identify log data entries for which no label is stored which have a same identifier for which label(s) are stored, and can associate those entries which the label(s). In some implementations, the publisher label extraction and filtering component 302 can filter inconsistent labels. For example, if the publisher label extraction and filtering component 302 identifies more than one set of labels associated with an identifier, a set of labels that is associated with a publisher that is deemed to be more reliable than another publisher can be selected, and the set of labels associated with the less-reliable publisher can be, for example, discarded or discounted.

A reach reporting pipeline 308 can aggregate the publisher labels data 304 to generate aggregated data that is stored in an aggregated data store 310. The aggregated data store 310 can include data that represents a distribution across a plurality of demographic categories. A correction matrix training component 312 can use training data 314 produced by a training data extraction component 316 to build a correction matrix 318. For example, the correction matrix training component 312 can use the training data and a non-negative least squares solver to build the correction matrix 318. The training data extraction component 316 can create the training data 314, based at least in part on information from historical campaigns. For example, the training data extraction component 316 can access historical data from past campaigns that includes demographic label information and can also access demographic label information from a panel logs datastore 319. The historical data can be used in the right-hand-side of an equation used in a training process and the panel demographic information can be used in the left-hand-side of the equation (e.g., such as the equation Y=alpha-value*AX+(1−alphavalue)*BX/|BX| described above).

The correction matrix 318 can be used by a reporting UI (user interface) component 320. The reporting UI component 320 can receive a request for a report for a campaign. The reporting UI component 320 can query the aggregated data store 310 for demographic distribution data corresponding to the campaign. The reporting UI component 320 can apply the correction matrix 318 to the demographic distribution data to determine a corrected distribution. The counts for each demographic label in the corrected distribution can be extrapolated to overall identifier counts for the campaign to determine an overall distribution for the campaign. The reporting component UI 320 can use an identifier to user model 322 to determine a user reach count for the campaign for each demographic label. The reach counts can be used to create a gross ratings point report that is presented in response to the report request. In some implementations, the identifier to user model 322 is trained and evaluated using information in the panel logs datastore 319.

In some implementations, instead of the reporting UI component 320 applying the correction matrix 318, the aggregated data store 310 can include entries that are annotated with multiple label/weight pairs, where a label-weight pair represents a row of an instance of the correction matrix 318 at a particular point in time. In response to a query, the reporting UI component 320 (or the reach reporting pipeline 308, on behalf of the reporting UI component 320) can, for each demographic category, determine label-weight counts for the demographic category, multiply such counts by a respective weight, and sum the weighted counts. Such decoupling of the reporting UI component 320 from the correction matrix 318 can result in several advantages. For example, such an approach can allow non-linear correction methodologies (e.g., propensity weights) and can reduce inconsistencies and anomalies that may otherwise be introduced by updates to the correction matrix 318.

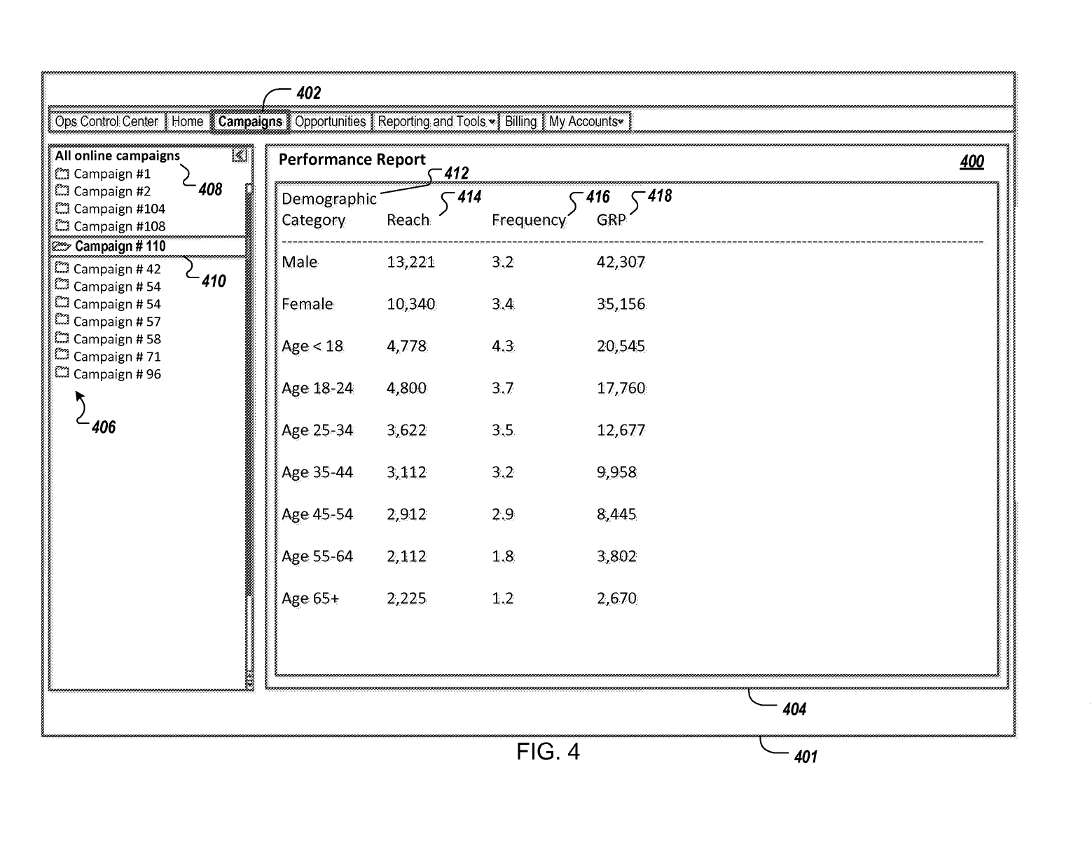

FIG. 4 illustrates an example performance report 400 displayed on a campaign management user interface 401. The user interface 401 can be included, for example, in one or more user interfaces that a user, such as a campaign sponsor, can use to configure and monitor a campaign. The sponsor can select a tab 402 to display a campaign configuration area 404. The sponsor can view a list 406 of campaigns by selecting a control 408. The sponsor can view information for an existing campaign in the campaign configuration area 404 by selecting the name of an existing campaign (e.g., a name 410) in the campaign list 406. For example, the sponsor can select a control (not shown) to view the report 400. The report 400 includes information for a set of demographic categories 412 (e.g., in this example, gender and age categories). For each demographic category 412, the report 400 includes reach 414, frequency 416, and GRP 418 information.

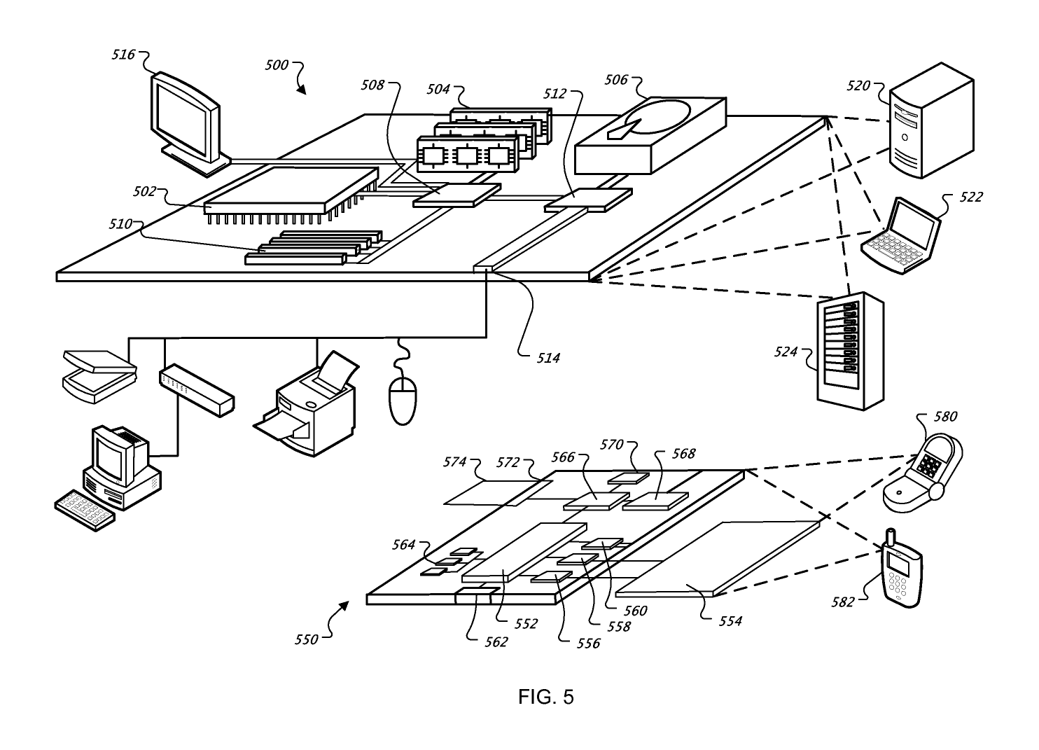

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is not a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communication audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying a campaign associated with the delivery of an electronic media item over an online network;
identifying data associated with impressions of electronic media items over the online network, each entry in the data including an identifier associated with a requesting device that was served a given impression;
determining a number of unique identifiers that received impressions of the electronic media item and a number of views of the electronic media item per identifier;
identifying a plurality of demographic categories;
identifying, from the unique identifiers, labeled identifiers, wherein a labeled identifier is able to be resolved to a particular user that has known demographic characteristics;
using the labeled identifiers, determining a number of identifiers and views per demographic category for the campaign;
accumulating the un-labeled identifiers to produce a count of un-labeled identifiers and views;
determining, for the labeled identifiers, a distribution across the plurality of demographic categories;
adjusting for errors in the determined distribution including compensating for a first error factor associated with a known error bias in the number of labeled identifiers and a second error factor associated with an underrepresentation of any group in the demographic characteristics;
determining an overall distribution among the demographic categories for impressions using the determined distribution and the first and second error factors; and
applying the overall distribution to a total number of unique identifiers and views including applying the overall distribution to the un-labeled identifiers to determine the overall distribution of identifiers and views per demographic category for the campaign.

2. The method of claim 1 wherein the identifiers are cookies.

3. The method of claim 1 further comprising determining a number of people that viewed the electronic media item in a given demographic category based at least in part on the total number of unique identifiers.

4. The method of claim 3 further comprising determining a GRP (Gross Rating Point) for the campaign for a demographic category as the number of people times the number of views in the demographic category divided by a total number of people available in the demographic category in a given region.

5. The method of claim 4 wherein the region is a country.

6. The method of claim 1 wherein the electronic media item is an advertisement.

7. The method of claim 1 wherein the distribution is defined by a vector X, wherein the i-th component of X is the fraction of labeled identifiers in the i-th demographic category.

8. The method of claim 7 further comprising determining an alpha-value for the campaign, where the alpha-value represents a fraction of labeled identifiers to unlabeled identifiers; and using the alpha-value when adjusting for errors.

9. The method of claim 8 wherein adjusting for errors includes determining a Y, where Y=alpha-value*AX+(1−alpha-value)*BX/|BX|, where A and B are predetermined matrices.

10. The method of claim 9 wherein determining an overall distribution among the demographic categories for impressions further includes extrapolating demographic identifier distribution to all identifiers including multiplying Y by the number of unique identifiers for the campaign.

11. The method of claim 1 wherein adjusting for errors further includes adjusting to compensate for errors in assigning users labels that are in the data.

12. The method of claim 1 wherein adjusting for errors further includes adjusting for bias in a labeling methodology used to label users.

13. The method of claim 1 wherein adjusting for errors further includes adjusting for underrepresentation of a demographic group in the demographic categories based at least in part on the labels.

14. The method of claim 1 wherein determining the number of unique identifiers that received impressions of the electronic media item is based at least in part on a calibration panel.

15. The method of claim 14 wherein the second error factor compensates for demographic bias in the calibration panel.

16. The method of claim 1 wherein the data is log data.

17. A computer program product tangibly embodied in a computer-readable storage device and comprising instructions that, when executed by a processor, cause the processor to:
identify a campaign associated with the delivery of an electronic media item over an online network;
identify data associated with impressions of electronic media items over the online network, each entry in the data including an identifier associated with a requesting device that was served a given impression;
determine a number of unique identifiers that received impressions of the electronic media item and a number of views of the electronic media item per identifier;
identify a plurality of demographic categories;
identify, from the unique identifiers, labeled identifiers, wherein a labeled identifier is able to be resolved to a particular user that has known demographic characteristics;
use the labeled identifiers to determine a number of identifiers and views per demographic category for the campaign;
accumulate the un-labeled identifiers to produce a count of un-labeled identifiers and views;
determine, for the labeled identifiers, a distribution across the plurality of demographic categories;
adjust for errors in the determined distribution including compensating for a first error factor associated with a known error bias in the number of labeled identifiers and a second error factor associated with an underrepresentation of any group in the demographic characteristics;
determine an overall distribution among the demographic categories for impressions using the determined distribution and the first and second error factors; and
apply the overall distribution to a total number of unique identifiers and views including applying the overall distribution to the un-labeled identifiers to determine the overall distribution of identifiers and views per demographic category for the campaign.

18. The product of claim 17 wherein the identifiers are cookies.

19. The product of claim 17 further comprising instructions that, when executed by the processor, cause the processor to determine a number of people that viewed the electronic media item in a given demographic category based at least in part on the total number of unique identifiers.

20. The product of claim 17 further comprising instructions that, when executed by the processor, cause the processor to determine a GRP (Gross Rating Point) for the campaign for a demographic category as the number of people times the number of views in the demographic category divided by a total number of people available in the demographic category in a given region.

21. A system comprising:
a content management system;
log data; and
panel data;
wherein the content management system is configured to:
identify a campaign associated with the delivery of an electronic media item over an online network;
identify, from the log data, data associated with impressions of electronic media items over the online network, each entry in the data including an identifier associated with a requesting device that was served a given impression;
determine a number of unique identifiers that received impressions of the electronic media item and a number of views of the electronic media item per identifier;
identify a plurality of demographic categories;
identify, from the unique identifiers, labeled identifiers, wherein a labeled identifier is able to be resolved to a particular user that has known demographic characteristics;
use the labeled identifiers to determine a number of identifiers and views per demographic category for the campaign;
accumulate the un-labeled identifiers to produce a count of un-labeled identifiers and views;
determine, for the labeled identifiers, a distribution across the plurality of demographic categories;
using the panel data, adjust for errors in the determined distribution including compensating for a first error factor associated with a known error bias in the number of labeled identifiers and a second error factor associated with an underrepresentation of any group in the demographic characteristics;
determine an overall distribution among the demographic categories for impressions using the determined distribution and the first and second error factors; and
apply the overall distribution to a total number of unique identifiers and views including applying the overall distribution to the un-labeled identifiers to determine the overall distribution of identifiers and views per demographic category for the campaign.

22. The system of claim 21 wherein the identifiers are cookies.

23. The system of claim 21 wherein the content management system is configured to determine a number of people that viewed the electronic media item in a given demographic category based at least in part on the total number of unique identifiers.

24. The system of claim 21 wherein the content management system is configured to determine a GRP (Gross Rating Point) for the campaign for a demographic category as the number of people times the number of views in the demographic category divided by a total number of people available in the demographic category in a given region.
